(19) United States
(12) Patent Application Publication
(10) Pub. No.: US 2014/0236331 A1
(43) Pub. Date: Aug. 21, 2014

(54) REAL-TIME DECISION MAKING IN SPORTS

(71) Applicants: Doron Lehmann, Kfar Vradim (IL); Oren Frishberg Barak, Tel Aviv (IL)

(72) Inventors: Doron Lehmann, Kfar Vradim (IL); Oren Frishberg Barak, Tel Aviv (IL)

(73) Assignee: SAP Portals Israel Ltd., Ra'anana (IL)

(21) Appl. No.: 13/772,665

(22) Filed: Feb. 21, 2013

(51) Int. Cl. G06F 17/00

(52) U.S. Cl. CPC G06F 17/60
USPC 700/93; 700/91

(57) ABSTRACT

The present disclosure involves systems, software, and computer implemented methods for calculating a proposed strategy for a sport. One example method includes identifying a set of historical data associated with prior performances of a sport, the set of historical data identifying a plurality of historical parameters associated with the prior performances; identifying a set of real-time situational data associated with a current performance of the sport in a game, the set of real-time situational data identifying a plurality of real-time parameters associated with the current performance; receiving a request to identify a proposed strategy associated with the current performance; calculating at least one proposed strategy associated with the current performance based at least in part on the set of historical data and the set of real-time situational data; and providing the at least one proposed strategy associated with the current performance in response to the received request.

### TECHNICAL FIELD

The present disclosure relates to computer-implemented methods, software, and systems for calculating a proposed strategy for a sport.

### BACKGROUND

Enterprise portals are frameworks for integrating information, people, and processes across organizational boundaries. Portals can provide a secure unified access point, often in the form of a web-based user interface, and are designed to aggregate and personalize information through application-specific portlets and components. One hallmark of enterprise portals is the decentralized content contribution and content management, which keeps the information always updated. In many cases, specific portal pages may be defined by a highly experienced administrator using a portal content administration environment or a key user within a particular organization using specific tools to define aspects, relationships, and connections for and between content provided within specific portal pages.

### SUMMARY

The present disclosure involves systems, software, and computer implemented methods for calculating a proposed strategy for a sport. One example method includes identifying a set of historical data associated with prior performances of a sport, the set of historical data identifying a plurality of historical parameters associated with the prior performances. A set of real-time situational data associated with a current performance of the sport in a game is identified, the set of real-time situational data identifying a plurality of real-time parameters associated with the current performance. A request to identify a proposed strategy associated with the current performance is received. At least one proposed strategy associated with the current performance is calculated based at least in part on the set of historical data and the set of real-time situational data. The at least one proposed strategy associated with the current performance is provided in response to the received request.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for calculating a proposed strategy for a sport.

FIG. 2 is a flowchart of an example method for calculating a proposed strategy for a sport.

FIG. 3A illustrates an example table used in calculating a proposed strategy.

FIGS. 3B, 3C, and 3D illustrate example graphs.

FIGS. 4A, 4B and 5 illustrate example user interfaces used to view, propose, and interact with one or more proposed strategies.

### DETAILED DESCRIPTION

Sports, such as team or individual sports, can involve many strategic decisions during competition. For instance, a coach may decide to substitute one player for another player in a game. As another example, the coach or a player may decide to perform a particular play as a next play in the game. As a particular example, a basketball coach may decide whether to perform a substitution of players, or, during a timeout, a play to instruct the team to execute. As another example, in American football, a coach can communicate to a team quarterback instructions about a next play to execute, in reference to a team playbook. Such decisions can be made based on personal experience and previous knowledge (e.g., watching prior game recordings, reviewing statistics, etc.) In many situations, decisions need to be made very quickly, and in some cases by one person (e.g., a head coach) without consulting with other people (e.g., assistant coaches) that might have additional knowledge that might influence a decision.

Statistical data related to various types of sports (professional, college, minor league, others) is accessible through various feeds and databases. Such statistical data can include information on players, teams, coaches, moves, and plays, to name a few examples. Statistical data can also be gathered during sporting events and made available during the game, in a real-time or near real-time timeframe (e.g., information can be available a few seconds after a play completes). A decision system can be used which identifies historical data associated with prior performances and real-time situational data associated with a current performance in response to a request for a strategy for the current performance.

The decision system can use an in-memory database that includes historical statistical data and is updated in real time with in-game real-time situational data. One or more suggested strategies can be determined and provided to a user based on the historical and real-time situational data. The strategies can be provided, for example, using a dashboard that is based on a portal infrastructure. Real-time probability of success of one or more suggested strategies can be presented, where the strategies are determined according to available resources (e.g., players), past and current (e.g., this game) performance, and real-time variables (e.g., time left in the game, wind factor, spread, game location, foul situation, and others). Plays can be determined, for example, based on a team play book. The in-memory database can include the playbook and the decision system can suggest a best possible play for a team in a given state in the game based on historical statistical data and current statistical data. As another example, the decision system can analyze available players and can suggest a better player to be used for a given play.

Suggested strategies or plays can be presented on a play board to a coach. The coach can decide to implement the suggested strategy or can select another suggested play (e.g., multiple plays can be presented according to determined likelihood of success). As another example, the coach can override a suggested play, such as by providing user input to move players on the play board to modify a play, or to use the play board to draw a new play.

Portal capabilities of the decision system can provide a collaboration workspace. For example, assistant coaches can each propose a preferred strategy to a head coach in real time, allowing a coach to consider opinions and suggestions from multiple people. As another example, a real time chat feature can be used by multiple users in the system, such as to post interesting and valuable information in the collaboration workspace. The portal can enable collaboration to be secure and based on a roles model. The roles model can allow different personnel to be exposed to different data, and to perform different actions.

Results of an implemented strategy can be determined and input into the decision system. For example, an indication of a selected play and results of the play can be saved in the decision system and used for future analysis. If a modification to a play is made, data indicating the modification can be stored and analyzed in order to improve strategy determination algorithms. A coach can review decisions and determine if the team performed the strategies correctly and if particular strategies proved valuable.

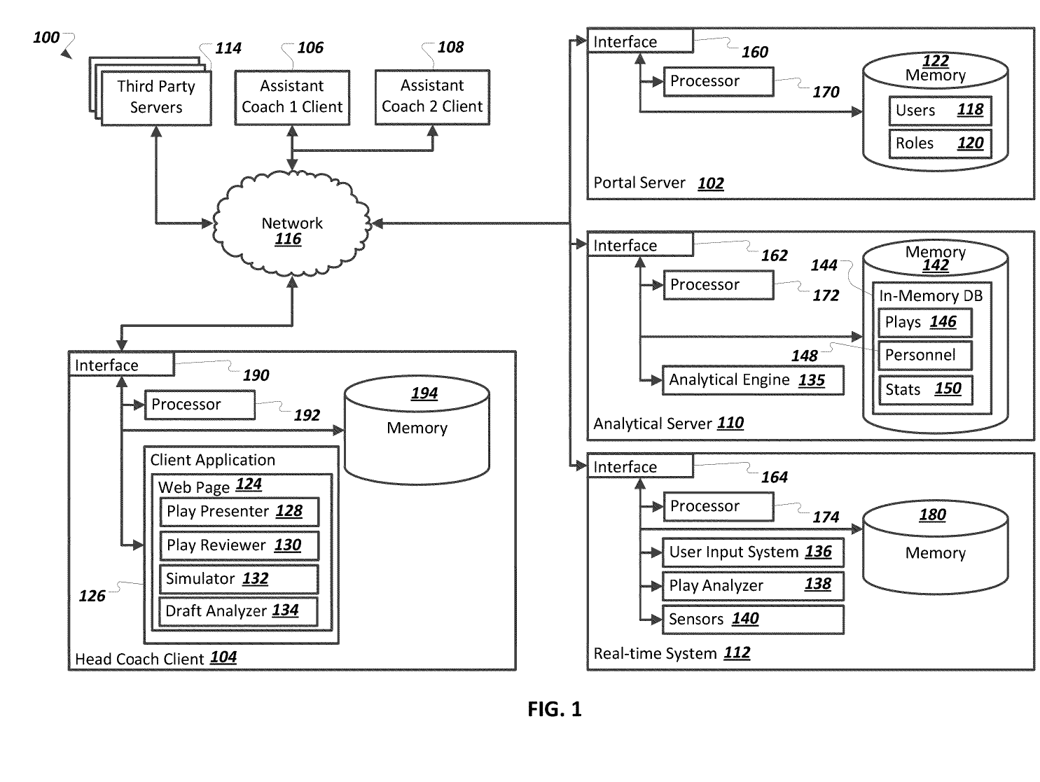

FIG. 1 is a block diagram illustrating an example system 100 for calculating a proposed strategy for a sport. Specifically, the illustrated environment 100 includes or is communicably coupled with a portal server 102, a head coach client device 104, a first assistant coach client device 106, a second assistant coach client device 108, an analytical server 110, a real-time system 112, one or more third party servers 114, and a network 116.

The portal server 102 can provide portal pages to the head coach client device 104, the first assistant coach client device 106, and the second assistant coach client device 108, and other authorized devices. The portal server 102 can manage multiple users (e.g., a head coach, multiple assistant coaches) and roles, and can store user information 118 and role information 120 in memory 122 of the portal server 102. The portal pages provided by the portal server 102 can provide a collaboration workspace for users of the portal. For example, a head coach and assistant coaches can communicate and collaborate using the portal, such as by using interactive chat and other portal features.

The portal server 102 can, for example, provide a web page 124 to the head coach client device 104, for presentation in an application/browser 126. The web page 124 can include various features, such as a play presenter 128, a play reviewer 130, a simulator 132, and a draft analyzer 134. The web page 124 or another web page can be provided to the first assistant coach client device 106 and the second assistant coach client device 108.

The real-time system 112 includes a user input system 136, a play analyzer 138, and one or more sensors 140. The user input system 136 can monitor for and accept user input from the head coach client device 104, the first assistant coach client device 106, and the second assistant coach client device 108, such as requests for strategy proposals, selection (e.g., implementation) of a selected strategy, input regarding other plays and strategies implemented during the game, and input regarding success of selected strategies. In some implementations, the real-time system 112 receives information about in-game plays and/or other information from a play-by-play feed provided by a user associated with the real-time system 112 and/or a third party server 114. In some implementations, the play analyzer 138 records and/or analyzes plays that occur during the game, such as by analyzing game video and/or live game statistics, where the live-game statistics may be received from a venue system or from a third party server 114. In some instances, user input associated with the analysis may be input to the play analyzer 138. The sensors 140 can provide real-time information relating to the game venue, such as temperature, noise level, wind speed, sun angle and brightness, and the game itself (e.g., goal line sensors, out of bounds detectors, etc.), among others.

A request for a strategy proposal for a game can be sent to the analytical server 110, such as from the real-time system 112. In some implementations, a user (e.g., the head coach) manually requests a strategy proposal, such as during a time out. As another example, requests for strategy proposals can be automatically sent on a periodic basis, such as every five minutes. In some implementations, requests for strategy proposals are automatically sent when an event occurs that corresponds to an in-game condition. For example, a request for a strategy proposal can automatically be sent when a time out is called, during “dead ball” moments, or on a rolling basis during in-game play.

As another example, the real-time system 110 (or the analytical server 112) can determine that one of the players is particularly effective (e.g., the player may be making shots at more than a threshold percentage for a predetermined number of shots (e.g., seventy percent or more for ten or more shots)). The effectiveness may be for a particular time or situation in the event, for a particular plan, or for any other situation. In response to such a determination, a request for a strategy proposal can be automatically sent to the analytical server 110, such as to determine whether to call more plays involving the player. As another example, if one of the players is particularly ineffective (e.g., the player is making shots at less than a threshold percentage for a predetermined number of shots), a request for a strategy proposal can be automatically sent to the analytical server 110, such as to determine whether to call less plays involving the player, to stop calling plays involving the player, or to take the player out of the game. As yet another example, if one of the opposing players is particularly effective, a request for a strategy proposal can be automatically sent to the analytical server 110, such as to determine whether to substitute in a player who has strong defensive capabilities. If one of the opposing players is particularly ineffective at defense (e.g., plays going against the player have succeeded at more than a threshold rate), a request for a strategy proposal can be automatically sent to the analytical server 110, such as to determine whether to call more plays directed against the player.

An analytical engine 135 associated with the analytical server 110 can, in response to a request for a strategy proposal, identify a set of historical data (e.g., historical parameters) associated with prior performances that relate to the game. The historical data can be associated, for example with prior performances of players on the team, players on the opposing team, the head coach of the team, and the opposing head coach, among others. The prior performances may have occurred, for example, during current and past seasons, events, matches, etc. In some implementations, some or all of the identified historical data is stored in memory 142 of the analytical server 110, such as in an in-memory database 144. The in-memory database 144 can include, for example, information on previously-performed plays 146, personnel 148, and other statistics 150. In some implementations, some historical data is accessed from one or more third party servers 114 and is stored in the in-memory database 144. In some implementations, the historical data is identified at the start of the game (e.g., in response to a start-of-game notification or to a determination that a game start time has occurred), rather than in response to a particular request for a strategy proposal. In such implementations, the identified historical data can be cached and used for all subsequent requests for strategy proposals received during the game.

The in-memory database 144 is a high-performance database management system (DBMS) that primarily relies on volatile electronic memory, such as random access memory (RAM), as opposed to magnetic, optical, removable, or other suitable non-electronic memory, for storage, retrieval, and processing of data. The reliance on electronic memory allows, in some implementations, for near-real-time aggregation, replication, synchronization, and processing of data. In some implementations, a persistency layer ensures that a copy of the in-memory database 144 is maintained on non-volatile magnetic, optical, removable, or other suitable non-electronic memory in the event of a power or other system failure in order to allow recovery of the in-memory database. In some implementations, the in-memory database 144 can be replicated to a conventional database for backup purposes, while at least a portion of the conventional database may be stored in the in-memory database 144 for analytical purposes.

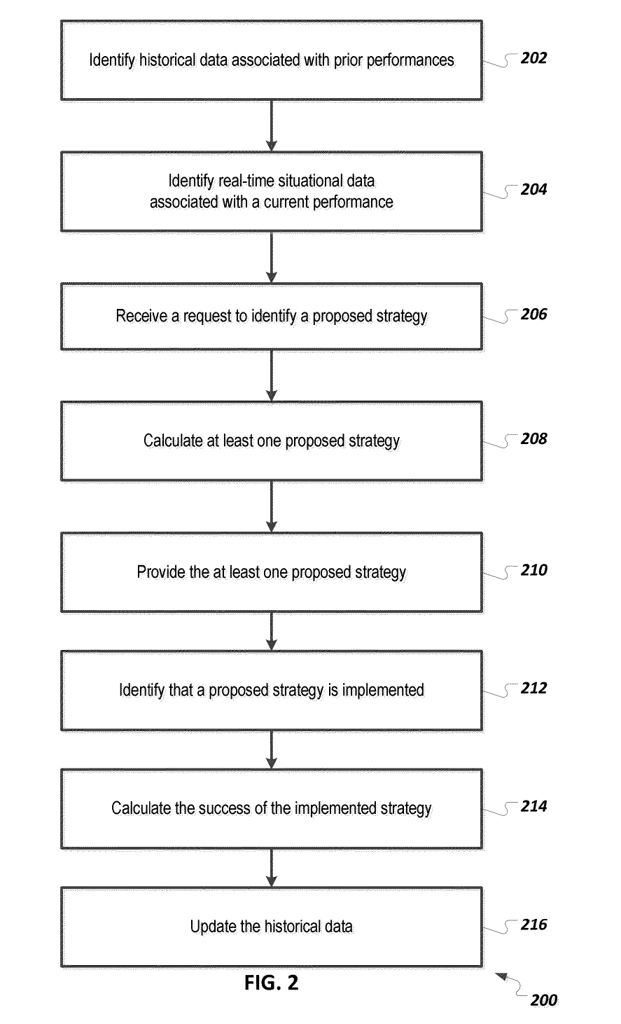

In general, the set of historical data can identify a plurality of historical parameters associated with prior performances. The plurality of historical parameters can include information associated with one or more of a weather description related to the prior performances, a time of day of the prior performances, and a physical location at which the prior performances were performed. The plurality of historical parameters can also include information identifying at least one of the following: a time remaining in the game, a score of the game, a location within a field of play for the game, a foul or penalty situation for the game, an opponent in the game, or the personnel involved, as well as other relevant data and information. Other examples of historical data are described below with respect to FIG. 2.

The real-time system 112 can provide real-time situational data associated with a current performance in the game to the analytical server 110. The set of real-time situational data can identify a plurality of real-time data and parameters associated with the current performance. The real-time situational data can include, for example, information associated with one or more of a weather description related to the current performance, a time of day of the current performance, a physical location at which the current performance is to be performed, a time remaining in the game, a score of the game, a location within a field of play for the game (of either personnel or the state of play), a foul or penalty situation for the game, or the opponent in the game, among others. Some of the real-time situational data (e.g., temperature) can be provided by the sensors 140.

In some implementations, the real-time system 112 can receive real-time situational data from one or more third party servers 114, such as in-game statistics and other information about plays occurring in the game. For example, a third party observer may be present in the venue and/or watching the game on video and recording observations about the game. The third party server 114 can provide an in-game feed which may be accessed by the real-time system 112. As another example, the user input system 136 may receive in-game information from the head coach client device 104, the first assistant coach client device 106, and/or the second assistant coach client device 108. For example, an assistant coach can input information about called plays and play results. In some instances, an assistant coach may be situated above the field or court in a position to observe the entire field or court, and may enter observations, such as using the second assistant coach client device 108. Other examples of real-time situational data are described below with respect to FIG. 2.

The analytical engine 135 can calculate one or more proposed strategies associated with the current performance based at least in part on the identified set of historical data and the identified set of real-time situational data. A proposed strategy can include, for example, one or more of inserting a particular personnel grouping for the current performance (e.g., substituting a player for another player), identifying roles for the particular personnel (e.g., a first player passing the ball, a second player shooting the ball), and identifying a particular play to execute for the current performance, among others. The analytical engine 135 can, for example identify a strategy that has a highest probability of success, based on the historical data and the real-time situational data. As another example, the analytical engine 135 can determine a top N most likely to succeed strategies, where N is a predetermined positive integer greater than one (e.g., five).

The analytical server 110 can provide the one or more proposed strategies to authorized users or devices, such as to the head coach client device 104, the first assistant coach client device 106, and the second assistant coach client device 108. For example, one or more proposed strategies can be displayed in the play presenter 128. Strategies can be ranked, for example, by probability of success. The head coach can, for example, select a strategy to view a diagram and details of a strategy. In some implementations, an assistant coach can suggest selection of a presented strategy by providing an input using the first assistant coach client device 106 or the second assistant coach client device 108. In some implementations, the head coach can use the play presenter 128 to modify a proposed strategy (e.g., move one or more players to different positions, re-assign roles, etc.). In some implementations, the head coach can use the play presenter 128 to diagram a new strategy (e.g., a play that is not included in a proposed strategy) and can receive feedback regarding an estimated chance of success for the new strategy. For example, information regarding the new strategy can be sent to the analytical server 110, and the analytical server 110 can determine a probability of success for the new strategy and send the probability to the head coach client device 104 for presentation on the head coach client device 104.

In some instances, the analytical server 110 can identify that a proposed strategy has been selected and/or implemented. For example, the analytical server 110 can identify an implementation of a strategy based on information received from the head coach client device 104, the first assistant coach client device 106, or the second assistant coach client device 108. As another example, the real time system 112 can automatically identify that a particular strategy was implemented (e.g., by the play analyzer 138 or based on information received from a third party server 114 regarding recent plays or events occurring in the game) and can provide a notification to the analytical server 110.

As another example, a coach can provide an input (e.g., to the web page 124) that indicates that a particular strategy was implemented. In some implementations, the coach can also input information indicating whether the strategy was successful, and/or to what degree the strategy was successful. For example, in American football, a goal of a running play can be to gain, on average, four yards. A particular implementation of the running play may yield three yards and may be designated as being partially successful based on the gain of three yards. Another particular implementation of the same running play may yield eight yards and may be designated as being extremely successful based on the gain of eight yards. In some implementations, the play reviewer 130 can be used to evaluate the success of implemented strategies. The play reviewer 130 can be used during or after the game.

In response to identifying that a particular strategy has been implemented, the analytical engine 135 can calculate the success of the implemented strategy. In implementations where an indication of success is input by a coach, the analytical engine 135 can receive and use such information in determining the success of the strategy. The real-time system 112 and/or the analytical server 110 may receive information from one or more third party servers 114 which indicate success of a strategy. For example, a play-by-play feed from a third party server 114 can indicate that a player scored a basket when a particular play was ran. The analytical server 110 can add information identifying the implemented strategy to historical data included in the in-memory database 144. For example, information identifying the implemented strategy can be added in association with the calculated success of the implemented strategy and real-time situational data associated with the implemented strategy. Additionally, information from the sensors 140 can be used to provide feedback on the relative success of the implemented strategy.

In some implementations, the simulator 132 can be used to simulate the implementing of one or more strategies. For example, a particular simulated game state can be generated, either using user input for game conditions and/or programmatically-generated (e.g., random) game conditions. Given a particular game state, the simulator 132 can simulate the effect of implementing one or more particular strategies in that game state. The simulator 132 can be used, for example, for training coaches and preparing future strategies. For example, a coach can be presented with a game state and can diagram a strategy. An estimated chance of success for the diagramed strategy can be determined and displayed. A proposed strategy (e.g., a strategy with a highest likelihood of success) for the given state can be determined, presented, and compared to the strategy diagramed by the coach.

In some implementations, a draft analyzer 134 can be used to assist in selection of players in a draft. For example, the draft analyzer 134 can identify statistics and characteristics associated with a potential draft pick (e.g., high school statistics, college statistics) and can then determine how the team may perform if the potential draft pick participates in various strategies. For example, the simulator 132 can be used to simulate a set of strategies that involve the potential draft pick as if the potential draft pick was included in the team. In some implementations, statistics for the potential draft pick can be weighted before being used in the simulator 132. For example, the size and quality of the college the potential draft pick attended, the quality of the conference, and the division (e.g., division one, division two) can affect weights applied to the statistics of the potential draft pick. For example, if the potential draft pick attended a school in a small-college conference not particularly known for basketball quality, statistics for the player can be downgraded (e.g., whereas if the potential draft pick attended a school in a basketball powerhouse conference, the statistics can be used without being downgraded). A similar process can be used for any player, including free agents, minor league players, and players currently on the team.

As used in the present disclosure, the term “computer” is intended to encompass any suitable processing device. For example, although FIG. 1 illustrates a single portal server 102, a single analytical server 110, and a single real-time system 112, the environment 100 can be implemented using two or more portal servers 102, two or more analytical servers 110, and/or two or more real-time systems 112, as well as computers other than servers, including a server pool. Indeed, the portal server 102, the analytical server 110, and the real-time system 112 may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the portal server 102, the analytical server 110, and the real-time system 112 may be adapted to execute any operating system, including Linux, UNIX, Windows, Mac OS®, Java™, Android™, iOS or any other suitable operating system. According to one implementation, the portal server 102 and/or the analytical server 110 may also include or be communicably coupled with an e-mail server, a Web server, a caching server, a streaming data server, and/or other suitable server.

Interfaces 160, 162, and 164 are used by the portal server 102, the analytical server 110, and the real-time system 112, respectively, for communicating with other systems in a distributed environment—including within the environment 100—connected to the network 116; for example, the head coach client device 104, the first assistant coach client device 106, and the second assistant coach client device 108, as well as other systems communicably coupled to the network 116. Generally, the interfaces 160, 162, and 164 each comprise logic encoded in software and/or hardware in a suitable combination and operable to communicate with the network 116. More specifically, the interfaces 160, 162, and 164 may each comprise software supporting one or more communication protocols associated with communications such that the network 116 or interface's hardware is operable to communicate physical signals within and outside of the illustrated environment 100.

The portal server 102, the analytical server 110, and the real-time system 112 respectively include one or more processors 170, 172, and 174. Each processor 170, 172, and 174 may be a central processing unit (CPU), a blade, an application specific integrated circuit (ASIC), a field-programmable gate array (FPGA), or another suitable component. Generally, each processor 170, 172, and 174 executes instructions and manipulates data to perform the operations of the respective portal server 102, analytical server 110, or real-time system 112. Specifically, each processor 170, 172, and 174 executes the functionality required to receive and respond to requests from the head coach client device 104, for example.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

Although shown separately, in some implementations, functionality of two or more systems or servers may be provided by a single system or server. For example, some or all of the functionality of the analytical server 110 may be provided by the portal server 102. As another example, some or all of the functionality of the real-time system 112 may be implemented in the head coach client device 104.

The portal server 102, the analytical server 110, and the real-time system 112 respectively include the memory 122, the memory 142, and a memory 180. In some implementations, some or all of the portal server 102, the analytical server 110, and the real-time system 112 include multiple memories. The memory 122, 142, and 180 may include any type of memory or database module and may take the form of volatile and/or non-volatile memory including, without limitation, magnetic media, optical media, random access memory (RAM), read-only memory (ROM), removable media, or any other suitable local or remote memory component. The memory 122, 142, and 180 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the respective portal server 102, analytical server 110, or real-time system 112.

While the description that follows is described in terms of the head coach client device 104, the same description can be applied to the first assistant coach client device 106, the second assistant coach client device 108, or to any client device included in the environment 100. The head coach client device 104 may generally be any computing device operable to connect to or communicate with the portal server 102, the analytical server 110, and the real-time system 112 via the network 116 using a wireline or wireless connection. In general, the head coach client device 104 comprises an electronic computer device operable to receive, transmit, process, and store any appropriate data associated with the environment 100 of FIG. 1. The head coach client device 104 can include one or more client applications, including the client application 126. The client application 126 is any type of application that allows the head coach client device 104 to request and view content on the head coach client device 104. In some implementations, the client application 126 can use parameters, metadata, and other information received at launch to access a particular set of data from the portal server 102 or the analytical server 110. In some instances, the client application 126 may be an agent or client-side version of the one or more enterprise applications running on the portal server 102. The client application 126 may also be or include a web browser for accessing the relevant information via the portal server 102.

An interface 190 of the head coach client device 104 can be for communicating with other systems in a distributed environment—including within the environment 100—connected to the network 116; for example, the portal server 102, the analytical server 110, or the real-time system 112, as well as other systems communicably coupled to the network 116. Generally, the interface 190 comprises logic encoded in software and/or hardware in a suitable combination and operable to communicate with the network 116. More specifically, the interface 190 may comprise software supporting one or more communication protocols associated with communications such that the network 116 or interface's hardware is operable to communicate physical signals within and outside of the illustrated environment 100.

The head coach client device 104 further includes one or more processors 192. Each processor 192 included in the head coach client device 104 may be a central processing unit (CPU), an application specific integrated circuit (ASIC), a field-programmable gate array (FPGA), or another suitable component. Generally, each processor 192 included in the head coach client device 104 executes instructions and manipulates data to perform the operations of the head coach client device 104. Specifically, each processor 192 included in the head coach client device 104 executes the functionality required to send requests to the portal server 102, the analytical server 110, or the real-time system 112 and to receive and process responses from the portal server 102, the analytical server 110, or the real-time system 112.

Memory 194 included in the head coach client device 104 may include any memory or database module and may take the form of volatile or non-volatile memory including, without limitation, magnetic media, optical media, random access memory (RAM), read-only memory (ROM), removable media, or any other suitable local or remote memory component. The memory 194 may store various objects or data, including user selections, caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the head coach client device 104.

In general, there may be any number of client devices associated with, or external to, the environment 100. For example, while the illustrated environment 100 includes one head coach client device 104, alternative implementations of the environment 100 may include any number of head coach client devices 104 communicably coupled to the network 116. For example, the environment 100 may be used for multiple simultaneous games occurring at different venues. Additionally, there may also be one or more additional client devices external to the illustrated portion of environment 100 that are capable of interacting with the environment 100 via the network 116. Further, the terms “client”, “client device” and “user” may be used interchangeably as appropriate without departing from the scope of this disclosure. Moreover, while the head coach client device 104 is described in terms of being used by a single user, this disclosure contemplates that many users may use one computer, or that one user may use multiple computers.

The head coach client device 104 is generally intended to encompass any client computing device such as a laptop/notebook computer, wireless data port, smart phone, personal data assistant (PDA), tablet computing device, one or more processors within these devices, or any other suitable processing device. For example, the head coach client device 104 may comprise a computer that includes an input device, such as a keypad, touch screen, or other device that can accept user information, and an output device that conveys information associated with the operation of the portal server 102, the analytical server 110, the real-time system 112, or the head coach client device 104 itself, including digital data, visual information, or a graphical user interface.

FIG. 2 is a flowchart of an example method 200 for calculating a proposed strategy for a sport. For clarity of presentation, the description that follows generally describes method 200 and related methods in the context of FIG. 1. However, it will be understood that method 200 and related methods may be performed, for example, by any other suitable system, environment, software, and hardware, or a combination of systems, environments, software, and hardware, as appropriate. For example, one or more of a client, the portal server, the analytical server, the real-time system, or other computing device (not illustrated) can be used to execute method 200 and related methods and obtain any data from the memory of a client, the portal server, the analytical server, the real-time system, or the other computing device (not illustrated).

At 202, a set of historical data associated with prior performances of a sport is identified. The set of historical data identifies a plurality of historical parameters associated with the prior performances. The plurality of historical parameters can include, but are not limited to, information associated with one or more of a weather description related to the prior performances, a time of day of the prior performances, and a physical location at which the prior performances were performed. The plurality of historical parameters can also include information identifying at least one of the following: a time remaining in the game, a score of the game, a location within a field of play for the game, a foul or penalty situation for the game, an opponent in the game, and game personnel. In some implementations, the set of historical data associated with prior performances of the sport is stored in an in-memory database to allow immediate access to and analysis of the data. In some implementations, some historical data is obtained from a third party server, such as before the start of a game, and is stored in the in-memory database for use during the game.

At 204, a set of real-time situational data associated with a current performance of the sport in a game is identified. The set of real-time situational data identifies a plurality of real-time parameters associated with the current performance. Similar to the historical data, the real-time situational data can include information associated with one or more of a weather description related to the current performance, a time of day of the current performance, a physical location at which the current performance is performed, a time remaining in the game, a score of the game, a location within a field of play for the game, a foul or penalty situation for the game, or an opponent in the game, among others.

The historical data can indicate many different conditions under which the prior performances were performed. Similarly, the real-time situational data can indicate many different conditions under which a current performance is to be performed. For example, some conditions can relate to the environment associated with a performance, such as a type of weather (e.g., sunny or cloudy), wind speed and direction, temperature, wind chill, sun angle, sun vs. shade on-field conditions, humidity, rain, or snow. Other environmental factors can include the venue in which a performance is performed, the noise level, the attendance in the stadium, whether the venue is an indoor venue or an outdoor stadium, the time of year, and the time of day (e.g., day game or night game).

Other conditions can include whether a game is a home, road, or neutral site game, an amount of days off since a last game (e.g., whether the game and a previous game are played on consecutive days), a number of days rest for particular players since a last game, and a number of minutes played, pitches thrown, passes made, or other amount indicating an amount of action taken by a player in various time frames, such as the current week, current month, current season, or career.

The historical data and/or real-time situational data can include information regarding personnel of the team and of the opposing team. For example, personnel information can include physical characteristics (e.g., height, weight, speed, jumping ability, arm length, left vs. right handed) of team players and opposing players.

Personnel information can also include various statistics for each player, including performance statistics for certain types of offensive and defensive plays, ratings or ranking for certain offensive or defensive skills, and performance in various skills in various environmental and situational conditions. As a particular example, historical data can indicate a player's offensive performance in late-game situations in night games in outdoor stadiums. The historical performance statistics can indicate performance against particular opposing players and against particular opposing coaches, for particular types of plays. The real-time situational data can indicate current performance statistics for the current game for various types of offensive and defensive actions, for both the team players and the current players. The real-time data can indicate a number of minutes or plays played in the current game for the team players and opponent players

The historical data and/or real-time situational data can include information about the team and the opposing team. For example, team information can include a current record for the team and the opposing team. Historical team statistics can indicate team performance of the team or the opposing team in various offensive and defensive categories. Real-time data can indicate team performance for the team and the opposing team in various offensive and defensive categories for the current game.

Real-time data can indicate current players in the game for the team and the opposing team and available bench players for the team and the opposing team. The real-time data can indicate tendencies of the opposing coach given the current game situation, such as a tendency of the opposing coach to make a substitution in the current game situation.

Some real-time situational data can be identified upon receipt of such information from one or more observers associated with the team. For example, a coach or other team personnel can input observations using a client device. Observations can include, for example, weather observations, observations about players (e.g., player fatigue, player injury), and observations about player performance. For example, a player may be currently particularly accurate, and simple performance statistics may not reflect that accuracy. For example, a basketball player may not just be making shots but may be making them with “nothing but net.” As another example, a quarterback may not just be completing passes, but may be completing them with particular speed and accuracy.

Some real-time situational data can be received using one or more sensors. For example, sensors can measure temperature, humidity, sun angle, and wind speed. Some real-time situational data can be received using one or more third party servers. For example, weather forecast and/or weather radar information can be obtained from a weather server. In some implementations, a manual input (e.g., “it is raining”) can be weighted higher than information received from a sensor or a third party server. Sensors can also be used to identify in-game events, play and strategy outcomes, and statistical data, among others.

The real-time data can include other information. For example, real-time data can include the current playbook, and performance information from recent practices for the current playbook. As another example, the real-time data can include game prediction information, such as which team is considered to be favored and by what point spread. Other suitable historical and real-time information may be used, as well.

At 206, a request is received to identify a proposed strategy associated with the current performance. The request can be received and processed at an analytical layer associated with the in-memory database. In some implementations, the request is a pre-defined query associated with a type of strategy which includes at least a portion of the real-time parameters associated with the current performance. The pre-defined query can be submitted by a user associated with a portal. An example of a pre-defined query can be: “which player is the best to perform action A when there are two minutes left in the game and the point spread is less than six points, given statistics for the season and the current game?”

At 208, at least one proposed strategy associated with the current performance is calculated based at least in part on the set of historical data and the set of real-time situational data. A proposed strategy can include at least one of the following: inserting a particular personnel grouping for the current performance, identifying a role for one or more of the personnel in the particular personnel grouping, and identifying a particular play to execute for the current performance.

In some implementations, a strategy that has a highest probability of success is calculated. As another example, a top N most likely to succeed strategies can be calculated, where N is a predetermined positive integer greater than one (e.g., three). In some implementations, the request includes an identification of at least one user-proposed strategy and a likelihood of success associated with the user-proposed strategy is calculated. In implementations where the historical data and the real-time situational data is in an in-memory database, calculation of the one or more proposed strategies can be completed much more quickly as compared to calculations which involve accessing data from disk or from other systems.

In some implementations, the historical data includes action and statistic information for each player for each of multiple locations on a court or field. For example, locations can be square portions (e.g., two feet by two feet) of the field that are each identifiable by an x, y coordinate. A set of possible actions (e.g., pass, shot, screen, block, rebound) can be defined. The historical data can include player statistics for prior performances relating to each action at each location, including information from earlier in the current event, match, or game. A likelihood of success for a particular play or strategy can be determined from such historical data. For example, a play can be defined as an aggregation of multiple actions at multiple locations, involving one or more players. For instance, an example play can be defined as a player A performing a block on square (1,2), a player B performing a block on square (2,3), and a player C shooting from square (3,4). A likelihood of success for the play can be calculated using a likelihood of success for each action. For instance, for the example play, a likelihood of the first action (e.g., 95%) can be added to a likelihood of the second action (e.g., 90%), and the resulting sum can be multiplied by a likelihood of the third action (e.g., 40%), resulting in a calculated likelihood of the example play of 37%.

At 210, the at least one proposed strategy associated with the current performance is provided in response to the received request. For example, at least one proposed strategy can be presented to a user via a dashboard associated with a portal. In implementations where the request includes a user-proposed strategy, feedback regarding the determined likelihood of success associated with the user-proposed strategy can be provided to the user.

At 212, an identification is made that a particular one of the at least one provided proposed strategies associated with the current performance is implemented. For example, an implementation can be identified in response to a notification received from a user associated with the team. As another example, an implementation can be identified based on information received automatically from a server or other system. Identification of strategy implementations can occur during or after the game.

At 214, the success of the implemented strategy is calculated. Success of the implemented strategy can be determined, for example, based on information received from a user associated with the team and/or based on information received automatically from a server or other system (e.g., a feed). In some implementations, the success of the implemented strategy is calculated at least in part on the relative success of the implemented strategy. For example, for some strategies, a variable number of points, yards, or other measurable outcome can result from the strategy.

At 216, the calculated success of the implemented strategy and the set of identified real-time situational data and real-time parameters associated with the current performance of the sport are used to update the set of historical data and historical parameters associated with prior performances of the sport. The updated historical data can be used in identifying strategies in response to future requests for strategies. Additional, alternative, and/or different operations may be used in other implementations.

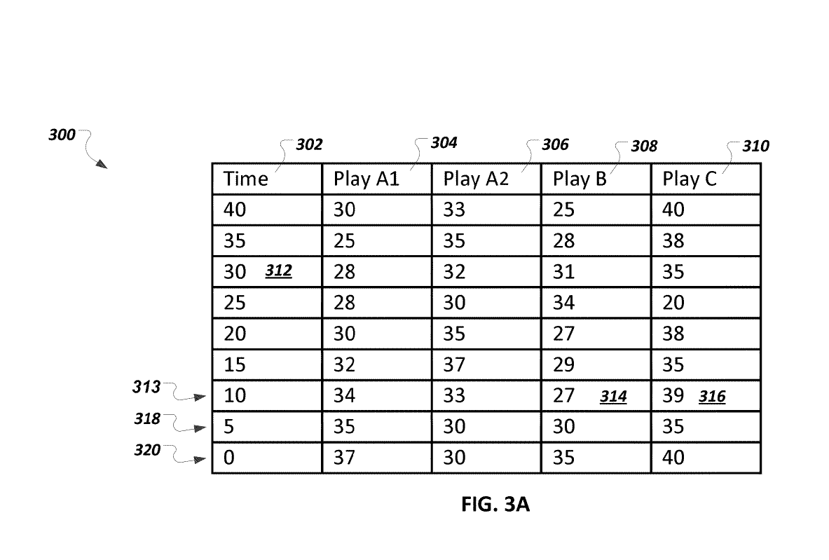

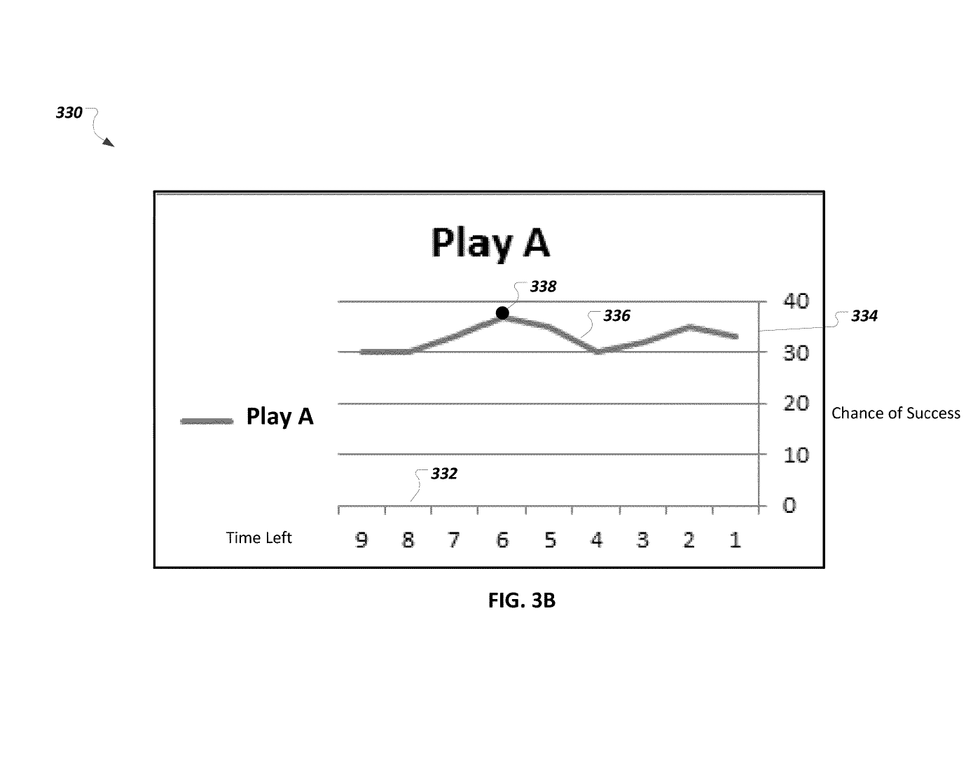

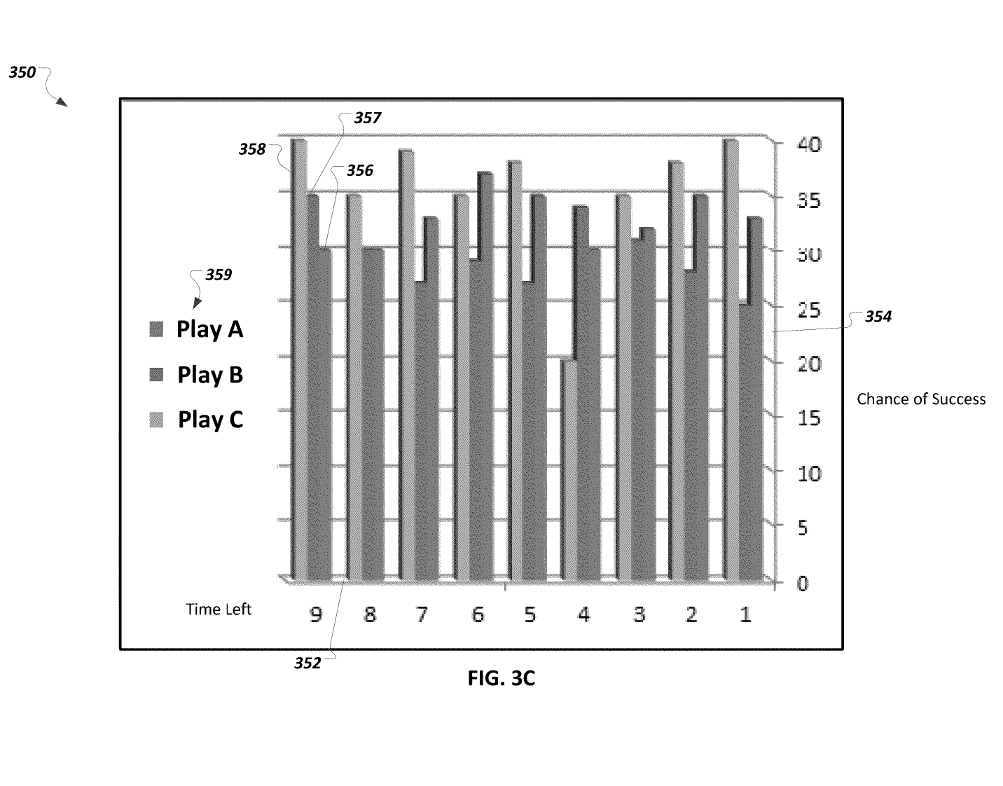

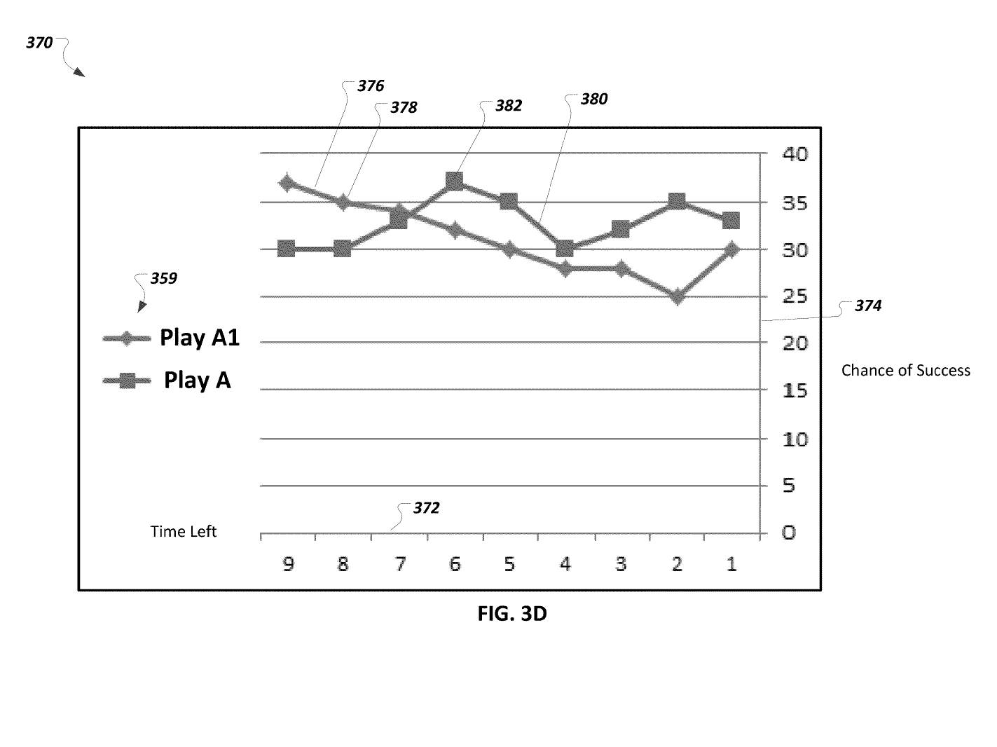

FIG. 3A illustrates an example table 300. The table 300 can be presented, for example, in a user interface, such as to a coach. The table 300 can be generated, for example, during a game, based on historical data and real-time situational data. As another example, the table 300 can be generated based on historical data but not real-time situational data (e.g., at a time not during a game).

The table 300 includes a time column 302 and play columns 304, 306, 308, and 310 corresponding to plays A1, A2, B, and C, respectively. Each of the play columns 304-310 can represent a particular play in a playbook. In some implementations, some or all of the play columns 304-310 can represent a particular play with a particular grouping of players and roles assigned to the play. For example, the play column 304 corresponding to play A1 can represent a play “A” with a first grouping of players and the play column 306 corresponding to play A2 can represent the play “A” with a second grouping of players.

The time column 302 includes values representing time left in a game (e.g., a cell 312 includes a value of thirty which represents thirty minutes left in a game). The columns 304-310 include values indicating an estimated percentage of success for a respective play at a particular time point in a game. For example, as shown in a row 313, a cell 314 indicates that with ten minutes left in the game, the play B has an estimated twenty-seven percent chance of success. As another example, a cell 316 indicates that with ten minutes left in the game, the play C has an estimated thirty-nine percent chance of success.

In some implementations, information from the table 300 can be presented in real time in a user interface, with a subset of rows displayed, based on the time of the game. For example, rows corresponding to time points no longer occurring in the game can be removed from the table 300 and rows corresponding to a current and upcoming time points can be presented. In some implementations, a play with a highest percentage of success for a current time point can be highlighted. For example, if there are ten minutes left in the game, row 313 and rows 318 and 320 can be presented, with the other rows corresponding to past time points not being presented. Row 313 can be presented with a visual indication (e.g., color highlighting), to indicate that row 313 corresponds to the current time point. Cell 318 can also be presented with a visual indication (e.g., flashing) to indicate that the play C has the highest probability of success for the current time point.

FIG. 3B illustrates an example graph 330. The graph 330 can be presented, for example, in a user interface, such as to a coach. The graph 330 can be generated, for example, during a game, based on historical data and real-time situational data. As another example, the graph 330 can be generated based on historical data but not real-time situational data (e.g., at a time not during a game).

The graph 330 includes an X-axis 332 which represents time left in a game and a Y-axis 334 which represents a percentage of success for a particular play A. A line 336 indicates probabilities of success for the play A for particular times remaining in the game. For example, a point 338 on the line 336 indicates that with six minutes remaining in the game, the probability of success for the play A is approximately thirty-seven percent.

FIG. 3C illustrates an example graph 350. The graph 350 can be presented, for example, in a user interface, such as to a coach. The graph 350 can be generated, for example, during a game, based on historical data and real-time situational data. As another example, the graph 350 can be generated based on historical data but not real-time situational data (e.g., at a time not during a game).

The graph 350 includes an X-axis 352 which represents time left in a game and a Y-axis 354 which represents a percentage of success for particular plays. The graph 350 includes a set of bars, for time points from nine to one minute remaining, where each set of bars includes a bar for a play A, a play B, and a play C, and where each bar represents a chance of success for the respective play at the corresponding time point. For example, at a time point corresponding to nine minutes remaining in the game, bars 356, 357, and 358 indicate probabilities of success for plays A, B, and C of approximately twenty-nine percent, thirty-four percent, and thirty-nine percent, respectively. As indicated by legend 359, each of the plays A, B, and C can be represented by bars having a particular color (e.g., blue for play A, red for play B, and green for play C).

FIG. 3D illustrates another example graph 370. The graph 370 can be presented, for example, in a user interface, such as to a coach. The graph 370 can be generated, for example, during a game, based on historical data and real-time situational data. As another example, graph 370 can be generated based on historical data but not real-time situational data (e.g., at a time not during a game).

The graph 370 includes an X-axis 372 which represents time left in a game and a Y-axis 374 which represents a percentage of success for a play. A line 376 indicates probabilities of success for a first play A1 for particular time amounts remaining in the game. For example, point 378 on the line 376 indicates that with eight minutes remaining in the game, the probability of success for the play A1 is approximately thirty-five percent. Line 380 indicates probabilities of success for a second play A for particular time amounts remaining in the game. For example, point 382 on the line 380 indicates that with six minutes remaining in the game, the probability of success for the play A is approximately thirty-seven percent.

The lines 376 and 380 can be visually distinguishable from one another. For example, the line 376 may be a first color (e.g., blue) and the line 380 may be a second color (e.g., red). As another example, points on the line 376 may be represented by a first symbol (e.g., a diamond) and points on the line 380 may be represented by a second symbol (e.g., a square). The lines may also have different patterns (e.g., dashed or not) or weights to provide distinguishing characteristics.

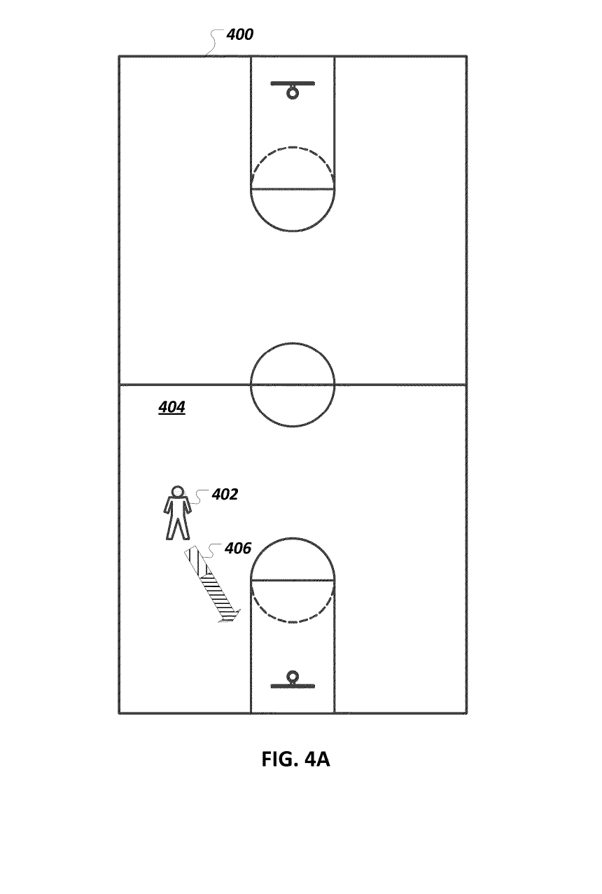

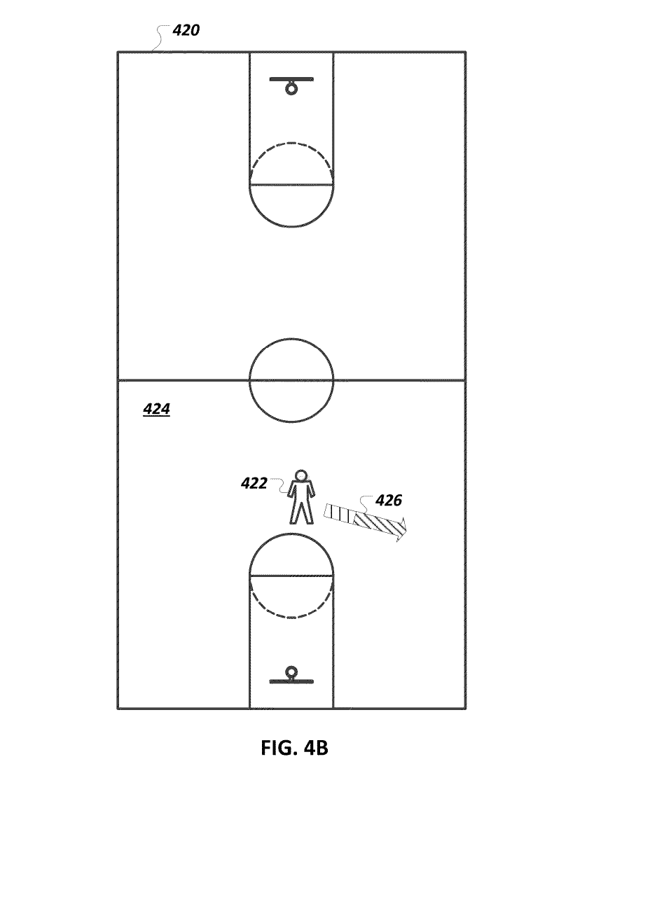

FIG. 4A illustrates an example user interface 400. The user interface 400 includes a representation of a player 402. For example, a user (e.g., a coach) can select the player 402 from a list of players (not shown) and can place the player 402 on a representation of a court 404. The user can designate a potential movement and/or action of the player 402, such as by selecting and placing an arrow 406 on the court 404 (e.g., via touch- or mouse-based input). The arrow 406 can be highlighted, such as with one or more colors, to indicate a predicted success of an action (e.g., a shot) at location(s) on the court 404 corresponding to the location of the arrow 406 or to the location of two or more portions of the arrow 406.

For example, a tail of the arrow 406 can be highlighted in a first color (e.g., red) and the tip of the arrow 406 can be highlighted in a second color (e.g., yellow). The first color can indicate a probability of success in a first range (e.g., zero to thirty percent) for an action occurring at a location corresponding to the tail of the arrow 406 and the second color can indicate a probability of success in a second range (e.g., thirty-one to fifty percent) for an action occurring at a location corresponding to the tip of the arrow 406. Probability of success can be determined, for example, during a live game, based on historical and real-time situational data. As another example, probability of success can be determined based on historical data alone (e.g., at a time other than during a game, such as during a practice or strategy meeting).

As illustrated in FIG. 4B, the user can, in a user interface 420, move a player 422 to a location on a court 424 and can indicate a destination for the player 420 (e.g., where the destination is different than the location of the player 402 in FIG. 4A), such as by using an arrow 426. The arrow 426 or portions of the arrow 426 can be highlighted to indicate one or more probabilities of success corresponding to an action (e.g., a shot) occurring at a location represented by the arrow 426 or by a portion of the arrow 426. For example, the tail of the arrow 426 can be highlighted in a first color (e.g., red) and the tip of the arrow 426 can be highlighted in a second color (e.g., green), where each of the first and second color indicate a probability of success within a respective range.

In general, the user interface 420 allows a user to design a play, such as by selecting and placing one or more players and by indicating actions and movements of one or more players. The user can use the interface 420 to design a play from scratch or can use the user interface 420 to modify a play suggested by the system. In each of these situations, the user interface 420 can indicate a determined chance of success for the illustrated play.

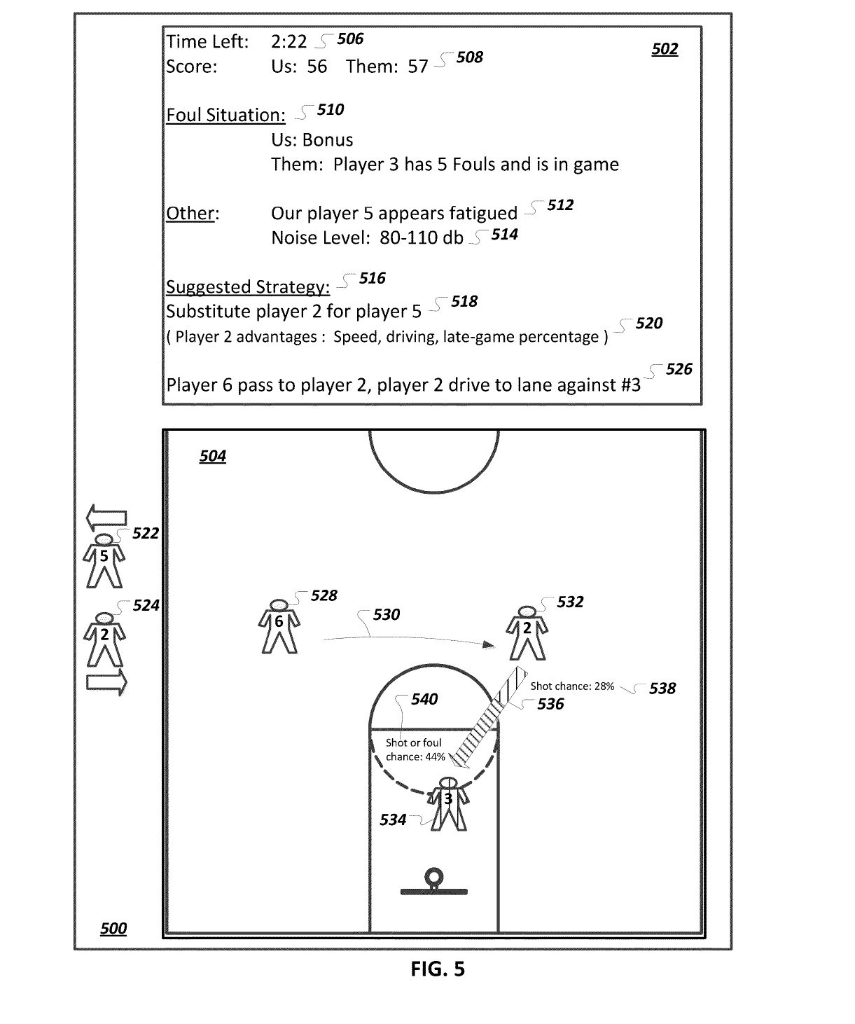

FIG. 5 illustrates an example user interface 500. The user interface 500 includes an information area 502 and a representation of a court 504. The user interface 500 can be presented, for example, on a user device used by a coach during a game.

As indicated by notes 506 and 508, there are two minutes and twenty-two seconds left in the game, with the team of the user losing by a score of fifty-six to fifty-seven. A foul-situation area 510 indicates that the team is in a bonus situation (e.g., the team will shoot free throws if the opposing team commits a foul) and that player number three (3) on the opposing team is one foul away from fouling out of the game. A note 512 indicates that player number five (5) on the team appears tired (e.g., such information may have previously been entered, for example, by an assistant coach using an application running on a different user device). A note 514 indicates that a recent noise level ranges from eighty to one hundred and ten decibels (e.g., the noise level may be determined from one or more sensors included in the arena).

A strategy section 516 outlines a suggested strategy, determined from the real-time situation information illustrated in the information area 502, other real-time situational information (e.g., player performance levels of players on the team and on the opposing team during the current game), and historical data regarding past performances. A note 518 indicates that a first portion of the suggested strategy is to substitute player number two (2) for player number five (5). Such a strategy may be proposed, for example, based at least in part on information relating to the note 512 regarding player five's (5) fatigue, and information relating to a note 520 regarding the speed and prior late-game performance of player number two (2). Representations 522 and 524 of player number five (5) leaving the game and player number two (2) entering the game, respectively, can be displayed on the side of the court 504.

A note 526 indicates that a second portion of the suggested strategy is to implement a play where player number six (6) passes the ball to player number two (2) and player number two (2) drives towards the basket towards player number three (3) of the opposing team (and shoots and possibly draws a foul on player number three (3)). The suggested play is diagramed in the court 504, with a representation of the player number six (6) 528, a representation of the pass 530, a representation of player number two (2) 532, and a representation of player number three (3) 534, on the opposing team.

An arrow 536 represents the drive towards the basket and a shot taken by player number two (2). A tail of the arrow 536 can be highlighted in a first color (e.g., red) and the tip of the arrow 536 can be highlighted in a second color (e.g., yellow). The first color can indicate a probability of success in a first range (e.g., zero to thirty percent) for an action (e.g., shot) occurring at a location corresponding to the tail of the arrow 536. A specific percentage (e.g., twenty-eight percent) can be presented in a note 538. The second color can indicate a probability of success in a second range (e.g., thirty-one to fifty percent) for an action (e.g., shot, being fouled) occurring at a location corresponding to the tip of the arrow 536. A specific percentage (e.g., forty-four percent) can be presented in a note 540. Probability of success can be determined, for example, based on historical data and on real-time situational data.

Other example uses can exist other than those illustrated in the preceding figures and accompany description. For example, a decision system can interface with television broadcasting systems or in-venue display systems, such as to present information about possible or implemented strategies. In some implementations, such information or other information can be displayed to fans, such as during the game on fan client devices (e.g., mobile devices). In some implementations, user interfaces presented to fans can be interactive, such as allowing fans to vote on suggested strategies or to vote regarding agreement with an implemented strategy.

The preceding figures and accompanying description illustrate example processes and computer-implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously, concurrently, and/or in different orders than as shown. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method comprising:
identifying a set of historical data associated with prior performances of a sport, the set of historical data identifying a plurality of historical parameters associated with the prior performances;
identifying a set of real-time situational data associated with a current performance of the sport in a game, the set of real-time situational data identifying a plurality of real-time parameters associated with the current performance;
receiving a request to identify a proposed strategy associated with the current performance;
calculating at least one proposed strategy associated with the current performance based at least in part on the set of historical data and the set of real-time situational data; and
providing the at least one proposed strategy associated with the current performance in response to the received request.

2. The method of claim 1, further comprising:
identifying that a particular one of the at least one provided proposed strategies associated with the current performance is implemented;
calculating the success of the implemented strategy; and
using the calculated success of the implemented strategy and the set of identified real-time situational data and real-time parameters associated with the current performance of the sport to update the set of historical data and historical parameters associated with prior performances of the sport.

3. The method of claim 1, wherein the success of the implemented strategy is calculated at least in part on the relative success of the implemented strategy.

4. The method of claim 1, wherein the plurality of historical parameters and the plurality of real-time parameters include information associated with at least one of a weather description related to the associated performances, a time of day of the associated performances, and a physical location at which the associated performances are performed.

5. The method of claim 1, wherein the plurality of historical parameters and the plurality of real-time parameters include information identifying at least one of the following: a time remaining in the game, a score of the game, a location within a field of play for the game, a foul or penalty situation for the game, or an opponent in the game.

6. The method of claim 1, wherein the proposed strategy includes at least one of the following: inserting a particular personnel grouping for the current performance, identifying a role for one or more of the personnel in the particular personnel grouping, and identifying a particular play to execute for the current performance.

7. The method of claim 1, where the request to identify the proposed strategy associated with the current performance comprises a pre-defined query associated with a type of strategy, the pre-defined query including at least a portion of the real-time parameters associated with the current performance, and the pre-defined query submitted by a user associated with a portal; and
where providing the at least one proposed strategy associated with the current performance in response to the received request comprises presenting the at least one proposed strategy to the user via a dashboard associated with the portal.

8. The method of claim 1, where the request to identify the proposed strategy associated with the current performance includes an identification of at least one user-proposed strategy;
where calculating the at least one proposed strategy associated with the current performance based at least in part on the set of historical data and the set of real-time situational data includes determining a likelihood of success associated with the at least one proposed strategy identified by the user; and
wherein providing the at least one proposed strategy associated with the current performance in response to the received request includes providing feedback to the user regarding the determined likelihood of success associated with the at least one user-proposed strategy.

9. The method of claim 1, where the set of historical data associated with prior performances of the sport is stored in an in-memory database, and where the request is received and processed at an analytical layer associated with the in-memory database, based at least in part on the set of real-time situational data identifying the plurality of real-time parameters associated with current performance.

10. A system comprising:
one or more computers associated with an enterprise portal; and
a computer-readable medium coupled to the one or more computers having instructions stored thereon which, when executed by the one or more computers, cause the one or more computers to perform operations comprising:
identifying a set of historical data associated with prior performances of a sport, the set of historical data identifying a plurality of historical parameters associated with the prior performances;
identifying a set of real-time situational data associated with a current performance of the sport in a game, the set of real-time situational data identifying a plurality of real-time parameters associated with the current performance;
receiving a request to identify a proposed strategy associated with the current performance;
calculating at least one proposed strategy associated with the current performance based at least in part on the set of historical data and the set of real-time situational data; and
providing the at least one proposed strategy associated with the current performance in response to the received request.

11. The system of claim 10, the operations further comprising:
identifying that a particular one of the at least one provided proposed strategies associated with the current performance is implemented;
calculating the success of the implemented strategy; and
using the calculated success of the implemented strategy and the set of identified real-time situational data and real-time parameters associated with the current performance of the sport to update the set of historical data and historical parameters associated with prior performances of the sport.

12. The system of claim 10, wherein the success of the implemented strategy is calculated at least in part on the relative success of the implemented strategy.

13. The system of claim 10, wherein the plurality of historical parameters and the plurality of real-time parameters include information associated with at least one of a weather description related to the associated performances, a time of day of the associated performances, and a physical location at which the associated performances are performed.

14. The system of claim 10, wherein the plurality of historical parameters and the plurality of real-time parameters include information identifying at least one of the following: a time remaining in the game, a score of the game, a location within a field of play for the game, a foul or penalty situation for the game, or an opponent in the game.

15. A computer program product encoded on a non-transitory storage medium, the product comprising non-transitory, computer readable instructions for causing one or more processors to perform operations comprising:
identifying a set of historical data associated with prior performances of a sport, the set of historical data identifying a plurality of historical parameters associated with the prior performances;
identifying a set of real-time situational data associated with a current performance of the sport in a game, the set of real-time situational data identifying a plurality of real-time parameters associated with the current performance;
receiving a request to identify a proposed strategy associated with the current performance;
calculating at least one proposed strategy associated with the current performance based at least in part on the set of historical data and the set of real-time situational data; and
providing the at least one proposed strategy associated with the current performance in response to the received request.

16. The product of claim 15, the operations further comprising:
identifying that a particular one of the at least one provided proposed strategies associated with the current performance is implemented;
calculating the success of the implemented strategy; and
using the calculated success of the implemented strategy and the set of identified real-time situational data and real-time parameters associated with the current performance of the sport to update the set of historical data and historical parameters associated with prior performances of the sport.

17. The product of claim 15, wherein the success of the implemented strategy is calculated at least in part on the relative success of the implemented strategy.

18. The product of claim 15, wherein the plurality of historical parameters and the plurality of real-time parameters include information associated with at least one of a weather description related to the associated performances, a time of day of the associated performances, and a physical location at which the associated performances are performed.

19. The product of claim 15, wherein the plurality of historical parameters and the plurality of real-time parameters include information identifying at least one of the following: a time remaining in the game, a score of the game, a location within a field of play for the game, a foul or penalty situation for the game, or an opponent in the game.

20. The product of claim 15, wherein the proposed strategy includes at least one of the following: inserting a particular personnel grouping for the current performance, identifying a role for one or more of the personnel in the particular personnel grouping, and identifying a particular play to execute for the current performance.
